(19) United States
(12) Patent Application Publication
(10) Pub. No.: US 2024/0125365 A1
(43) Pub. Date: Apr. 18, 2024

(54) PAD LINER, BRAKE DEVICE, AND VEHICLE

(71) Applicant: HYUNDAI MOBIS CO., LTD., Seoul (KR)

(72) Inventors: Kang Kuk LEE, Hwaseong-si (KR); Seong Hwan AHN, Seoul (KR); Wan Kyu LEE, Yongin-si (KR); In Ho LEE, Seoul (KR); Yeong Bin CHO, Yongin-si (KR)

(73) Assignee: HYUNDAI MOBIS CO., LTD., Seoul (KR)

(21) Appl. No.: 18/487,710

(22) Filed: Oct. 16, 2023

(30) Foreign Application Priority Data
Oct. 18, 2022 (KR) 10-2022-0134186

(51) Int. Cl. F16D 65/097; F16D 55/225

(52) U.S. Cl. CPC F16D 65/0977; F16D 55/225; F16D 65/0972; F16D 2127/02

(57) ABSTRACT

A pad liner includes a first pad clip that surrounds and is coupled to a side protrusion protruding in a lateral direction from a brake pad, and a torque support located under the first pad clip and between a side surface of the brake pad and the caliper body. The torque support supports a braking torque. The first pad clip includes a reference surface located on one of a top surface and a bottom surface of the side protrusion, a vertical elastic portion located on an opposite side from the reference surface that pressurizes the side protrusion in a direction of the reference surface, and a clip side portion that connects the reference surface and the vertical elastic portion and surrounds a side surface of the side protrusion. The pad liner minimizes a vertical gap and movement of the brake pad.

### CROSS-REFERENCE TO RELATED APPLICATIONS

This application claims the benefit of Korean Patent Application No. 10-2022-0134186, filed on Oct. 18, 2022, which is hereby incorporated by reference as if fully set forth herein.

### TECHNICAL FIELD

The present embodiments relate to a brake device applicable to a vehicle and a vehicle with a brake device installed therein, and more particularly, to a brake device that simplifies a structure of a pad liner that supports a brake pad in a lateral direction of the brake pad and improves performance, and a vehicle equipped with the same.

### BACKGROUND

A brake device mounted in a vehicle is a device for decelerating, stopping, or maintaining a stopped state of a vehicle while driving and is located inside a rotating wheel, and brakes a vehicle by strongly pressing a disc-shaped brake disc rotating together with the wheel using brake pads from both sides.

In a conventional brake device, two brake pads disposed on both sides of a disc are supported to move forward or backward on an accommodation surface of a caliper body fixed to a vehicle. A pad support pin for guiding forward or backward movement of the brake pads, and a spring member for elastically supporting upper parts of two pad plates to prevent vibration of the pad plates and achieving a smooth return operation are installed.

The brake device may be largely divided into a drum-type brake device and a disc-type brake device. The drum-type brake device uses a method of stopping using a shoe in contact with an inner surface of a cylindrical drum, and the disc-type brake device stops the brake pad by contacting a surface of the brake disc rotating together with the wheel. The disc-type brake device has a caliper that is a housing in which the brake pad is located and is coupled to the wheel, and has a simpler structure and a smaller volume than the drum-type brake device and thus is applied to passenger cars. Only one of the two types may be used or the disc-type brake device and the drum-type brake device may be applied the front and to the rear, respectively.

A conventional brake device includes a pair of brake pads disposed on both sides of a brake disc such that first surfaces on which a friction material is located face each other. The brake pad is supported in a caliper body fixed to a vehicle in a state of being able to move forward and backward in a first direction toward the brake disc and a second direction opposite to the first direction.

The caliper body may be coupled to the brake pads on left and right sides of the respective brake pads so as to move in the first direction and the second direction, and may include a pad liner located between the brake pad and the caliper body.

The pad liner may include a plurality of elastic portions to support the brake pad such that the brake pad does not sag or deviate to one side in a horizontal direction and to apply a restoring force in the second direction.

The pad liner guides the brake pad to be positioned at a correct location without being biased to one side, but a clearance between the pad liner, the brake pad, and the caliper may reduce a braking performance of the brake device, generate noise, and have an influence on drag.

Because of such problem, a return operation of the brake pad is incomplete and drag characteristics and braking noise are caused, so that there is a need to reduce such problem.

### SUMMARY

Embodiments of the present disclosure are to provide a pad liner that minimizes a clearance by reducing a gap between a reference surface and a vertical elastic portion of a pad liner to solve the above-mentioned problem.

In addition, embodiments of the present disclosure are to provide a pad liner including a separate return spring that may increase a return elastic force.

It will be appreciated by persons skilled in the art that the objects that could be achieved with the present disclosure are not limited to what has been particularly described hereinabove and the above and other objects that the present disclosure could achieve will be more clearly understood from the following detailed description.

Provided is a pad liner seated within a caliper body and supporting a brake pad, the pad liner including a first pad clip that surrounds and is coupled to a side protrusion protruding in a lateral direction from the brake pad, and a torque support located under the first pad clip and located between a side surface of the brake pad and the caliper body, wherein the torque support supports a braking torque, wherein the first pad clip includes a reference surface located on one of a top surface and a bottom surface of the side protrusion, a vertical elastic portion located on an opposite side of the reference surface and pressurizing the side protrusion in a direction of the reference surface, and a clip side portion that connects the reference surface and the vertical elastic portion to each other and surrounds a side surface of the side protrusion.

The clip side portion may have a length greater than a length of the side protrusion of the brake pad, and an angle between the vertical elastic portion and the clip side portion may be equal to or smaller than 90°.

The pad liner may further include a caliper clip located on the first pad clip, wherein an upper protrusion protruding from the caliper body is inserted into the caliper clip. A lower portion of the caliper clip may be an upper portion of the first pad clip. The first pad clip and the torque support may include a pair of first pad clips and a pair of torque supports, respectively, and the pad liner may include a bridge that connects upper portions of the pair of first pad clips to each other.

The pad liner may further include a return spring that restores the brake pad to an original location thereof, and the return spring may include a second pad clip located inwardly of the first pad clip and surrounding the side protrusion of the brake pad in a direction perpendicular to the first pad clip, and a return elastic portion extending from the second pad clip in a return direction of the brake pad and bent in a U-shape such that an end thereof is seated on the caliper body.

The second pad clip may include a fixing protrusion inserted into a fixing groove defined in the side protrusion of the brake pad.

The second pad clip may further include a centering elastic portion protruding in a direction of the clip side portion and maintaining a gap from the clip side portion.

The clip side portion may further include a pad deviation preventing groove, wherein an end of the centering elastic portion is inserted into the pad deviation preventing groove.

According to another aspect of the present disclosure, provided is a pad liner seated within a caliper body and supporting a brake pad, the pad liner including a first pad clip that surrounds and is coupled to a side protrusion protruding in a lateral direction from the brake pad, a pad support located under the first pad clip and located between a side surface of the brake pad and the caliper body, wherein the pad support supports a braking torque, and a return spring that restores the brake pad to an original location thereof, wherein the return spring includes a second pad clip located inwardly of the first pad clip and surrounding the side protrusion of the brake pad in a direction perpendicular to the first pad clip, and a return elastic portion extending from the second pad clip in a return direction of the brake pad and bent in a U-shape such that an end thereof is seated on the caliper body.

According to another aspect of the present disclosure, provided is a brake device including a caliper body, a brake pad disposed in the caliper body and including side protrusions protruding in a lateral direction on left and right side surfaces thereof, respectively, and a pair of pad liners located between the caliper body and the left and right side surfaces of the brake pad, respectively, wherein the pad liner includes a first pad clip that surrounds and is coupled to the side protrusion protruding in the lateral direction from the brake pad, and a pad support located under the first pad clip and located between the side surface of the brake pad and the caliper body, wherein the pad support supports a braking torque, wherein the first pad clip includes a reference surface located on one of a top surface and a bottom surface of the side protrusion, a vertical elastic portion located on an opposite side of the reference surface and pressurizing the side protrusion in a direction of the reference surface, and a clip side portion that connects the reference surface and the vertical elastic portion to each other and surrounds a side surface of the side protrusion.

The clip side portion may have a length greater than a length of the side protrusion of the brake pad, and an angle between the vertical elastic portion and the clip side portion may be equal to or smaller than 90°.

The brake device may further include a return spring that restores the brake pad to an original location thereof, and the return spring may include a second pad clip located inwardly of the first pad clip and surrounding the side protrusion of the brake pad in a direction perpendicular to the first pad clip, and a return elastic portion extending from the second pad clip in a return direction of the brake pad and bent in a U-shape such that an end thereof is seated on the caliper body.

The second pad clip may include a centering elastic portion protruding in a direction of the clip side portion and maintaining a gap from the clip side portion, and the clip side portion may include a pad deviation preventing groove, wherein an end of the centering elastic portion is inserted into the pad deviation preventing groove.

According to another aspect of the present disclosure, provided is a vehicle including a vehicle body, a wheel located beneath the vehicle body and rotating, a brake disc coupled to the wheel and rotating together with the wheel, a main braking caliper body, wherein one end of the brake disc is inserted into the main braking caliper body, a brake pad disposed in the caliper body and including side protrusions protruding in a lateral direction on left and right side surfaces thereof, respectively, and a pair of pad liners located between the caliper body and the left and right side surfaces of the brake pad, respectively, wherein the pad liner includes a first pad clip that surrounds and is coupled to the side protrusion protruding in the lateral direction from the brake pad, and a pad support located under the first pad clip and located between the side surface of the brake pad and the caliper body, wherein the pad support supports a braking torque, wherein the first pad clip includes a reference surface located on one of a top surface and a bottom surface of the side protrusion, a vertical elastic portion located on an opposite side of the reference surface and pressurizing the side protrusion in a direction of the reference surface, and a clip side portion that connects the reference surface and the vertical elastic portion to each other and surrounds a side surface of the side protrusion.

According to one of the embodiments of the present disclosure, the gap between the reference surface and the vertical elastic portion of the pad liner may be reduced to minimize the vertical gap and the movement of the brake pad.

Additionally, the return spring having the return force greater than the pad sliding force may be provided.

Additionally, the lateral gap of the brake pad may be kept constant using the center spring.

The effects that may be obtained from the present disclosure are not limited to the effects mentioned above, and other effects not mentioned may be clearly understood by those skilled in the art in the technical field to which the present disclosure belongs from the description below.

### BRIEF DESCRIPTION OF THE DRAWINGS

FIG. 1 is a front view of a brake device and a brake disc according to any one of embodiments of the present disclosure.

FIG. 2 is a diagram showing a conventional brake device.

FIG. 3 is a diagram showing conventional brake pad and pad liner.

FIG. 4 is a perspective view showing a brake device according to one of embodiments of the present disclosure.

FIG. 5 is a view showing a coupling portion of a brake pad of a brake device according to one of embodiments of the present disclosure.

FIG. 6 is a view showing a pad liner according to one of embodiments of the present disclosure.

FIG. 7 is a view showing a brake pad and a pad liner according to one of embodiments of the present disclosure.

FIG. 8 is a diagram showing a state in which a pad liner is coupled to a brake pad.

FIG. 9 is a diagram showing a return spring of a brake device according to one of embodiments of the present disclosure.

FIGS. 10 and 11 are diagrams showing a brake pad and a pad liner according to one of embodiments of the present disclosure.

### DETAILED DESCRIPTION

Hereinafter, the present disclosure will be described more fully with reference to the accompanying drawings, in which exemplary embodiments of the present disclosure are shown. The present disclosure may, however, be embodied in many different forms and should not be construed as being limited to the embodiments set forth herein; rather, these embodiments are provided so that this disclosure will be thorough and complete, and will fully convey the concept of the present disclosure to those skilled in the art.

Terms used in this disclosure are used to describe specified embodiments and are not intended to limit the scope of another embodiment. The terms of a singular form may include plural forms unless otherwise specified. As used herein, “comprises” and/or “comprising” does not exclude the presence or addition of one or more other components in addition to the stated components Like reference numerals refer to like elements throughout, and “and/or” includes each and every combination of one or more of the recited elements. Although “first”, “second”, etc. are used to describe various elements, these elements are not limited by these terms, needless to say. These terms are only used to distinguish one component from another. Therefore, needless to say, the first component mentioned below may be the second component within the spirit of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Spatially relative terms “below”, “beneath”, “lower”, “above”, “upper”, etc. may be used to easily describe a correlation between one component and other components. A spatially relative term needs to be understood as a term that includes different directions of components during use or operation in addition to directions shown in the drawings. For example, when a component shown in the drawing is turned over, a component described as “beneath” or “beneath” of another component may be placed “above” of the other component. Accordingly, the exemplary term “below” may include both directions below and above. Components may also be oriented in other orientations, and thus spatially relative terms may be interpreted according to orientation.

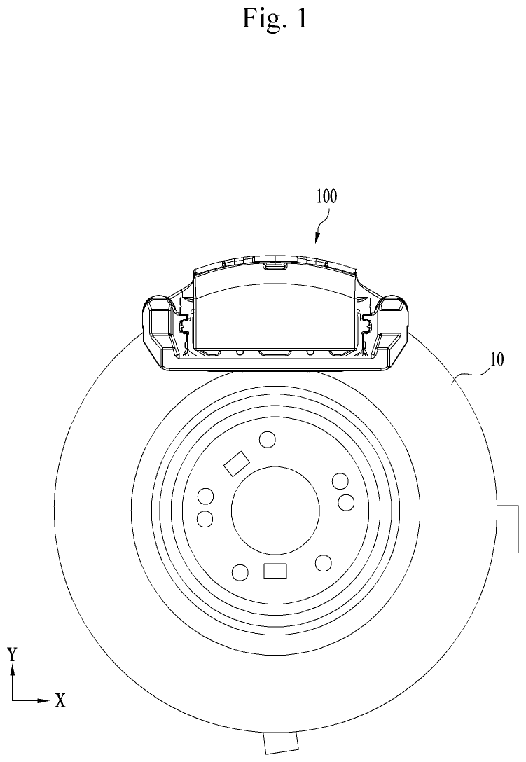

FIG. 1 is a front view of a brake device 100 and a brake disc 10 according to any one of embodiments of the present disclosure. Hereinafter, in describing the brake device 100, a reference of the up-down (y-axis) and left-right (x-axis) directions, and front and rear (z-axis) directions may be based on the brake device 100 illustrated in FIG. 1.

Wheels of the vehicle may be generally disposed on both left and right sides, and a front direction shown in FIG. 1 may be disposed to face the outside of the vehicle. Depending on a type of the brake device 100, front and rear shapes may have a symmetrical shape (opposed caliper brake), or a piston structure may be provided at only one side (sliding caliper brake).

The opposed caliper brake may use a method in which a brake pad part 120 is pressed from both sides to come in contact with the brake disc 10 in the state in which a main braking caliper body 110 is fixed. This method has excellent braking power in terms of a symmetrical structure, but since pistons for pressurization from both sides need to be located on both sides, the volume of an outer part of a wheel may increase and piston speeds on both sides need to be synchronized.

The sliding caliper may include a piston that presses only the brake pad 12 at one side and has a structure in which the main braking caliper body 110 slides and brakes by a reaction that pushes the brake disc with the brake pad at one side.

Since the main braking piston is provided on only one side, it is easy to implement the device, and there is an advantage that it is not necessary to adjust speeds of the pistons at both sides equally. However, braking force is inferior to the opposed caliper brake, and an opposed caliper brake system is introduced for high-end vehicles.

In the opposed caliper brake, the brake disc is always located at the center of the caliper body, but in the slide caliper brake, the location of the caliper body is slidably coupled to the brake disc.

Referring to FIG. 1, the brake device 100 may apply braking to the wheel of the vehicle by pressing a surface of the brake disc 10. The brake disc 10 and a knuckle assembly may be components connected to the wheels of the vehicle.

The brake disc 10 may rotate with rotation of the wheels while the vehicle drives. When the brake device 100 applies pressure to the brake disc 10, resistance may be generated to rotation of the brake disc 10, thereby reducing rotational speed of the wheel. That is, the vehicle may be braked.

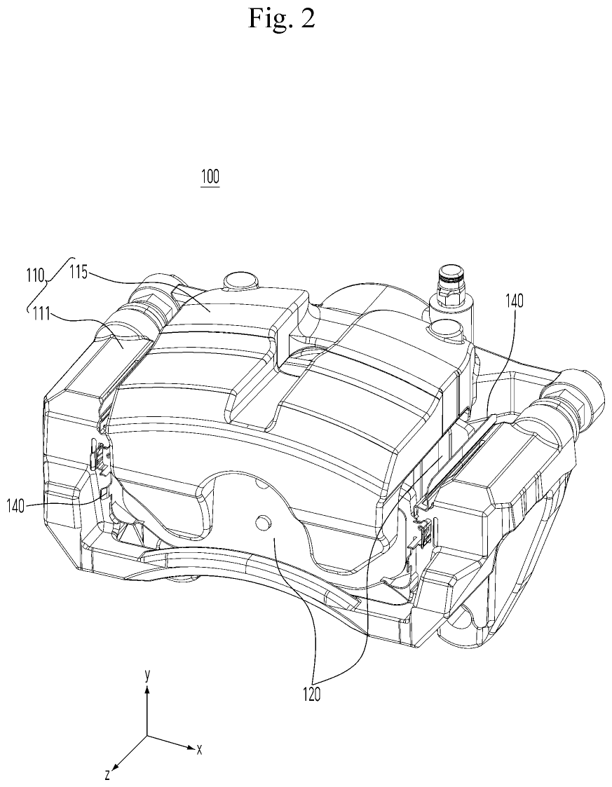

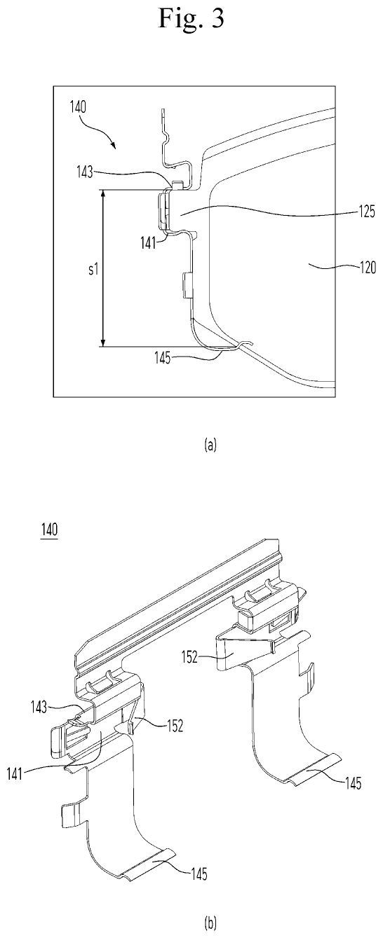

FIG. 2 is a diagram showing the conventional brake device 100, and FIG. 3 is a diagram showing conventional brake pad 120 and pad liner 140.

The brake device 100 is composed of the caliper body 110 into which one side of the brake disc 10 is inserted, the brake pad 120 mounted in the caliper body 110 and having a brake first surface facing the disc, and the pad liner 140 that is located between the caliper body 120 and the caliper body 110 and fixes a location of the brake pad 120.

The caliper body 110 may be composed of a first caliper body 111 on which the brake pad 120 is seated and located on left and right-side surfaces and a bottom surface of the brake pad 120, and a second caliper body 115 coupled to the first caliper body 111 from above and where a piston that pressurizes the brake pad 120 is located.

The pad liner 140 that is located on a side of the brake pad 120 and disposed between the brake pad 120 and the first caliper body 111 may have a leaf spring shape as shown in (b) in FIG. 3. The pad liner 140 guides the brake pad 120 to be fixed while maintaining a predetermined gap without being in direct contact with the caliper body 110.

To support the brake pad 120 without interfering with a movement thereof in a first direction toward the brake disc 10, a vertical elastic portion 145 that supports a lower portion of the brake pad 120 may be included. The vertical elastic portion 145 pressurizes the brake pad 120 in an upward direction, and a reference surface 143, which is an upper portion of a first pad clip 141 surrounding a side protrusion 125 of the brake pad 120, supports elasticity of the vertical elastic portion 145.

The movement of the pad during braking is determined by dimensional tolerances of the pad, the pad liner 140, and a torque member, and an assembly clearance caused by the dimensional tolerance becomes a gap that is generated by the pad movement during the braking. Such gap causes squeal noise when the pad movement occurs. As a distance between the reference surface and the vertical elastic portion 145 increases, the movement of the brake pad 120 increases during the braking, which increases the noise.

The conventional pad liner 140 realizes a function of a return spring 150 in one member. A return elastic portion 152 is in contact with the first surface, which is a friction surface of the brake pad 120, and applies a force in the second direction, which is the opposite direction, when the brake pad 120 moves in the first direction, thereby restoring the brake pad 120 to an original location thereof again.

The return elastic portion 152, which has a bent shape, has a problem of weak elasticity, and thus, has a problem in terms of durability. In addition, as described above, when the elasticity for fixing in a vertical direction is increased to reduce the gap in the vertical direction, a friction increases, so that a greater elasticity of the return elastic portion 152 is also required.

Accordingly, the present disclosure provides a pad liner 140 including a return spring 150 that may limit the movement by reducing the vertical gap compared to the conventional pad liner 140 and while providing a force equal to or greater than the friction force of the conventional pad liner.

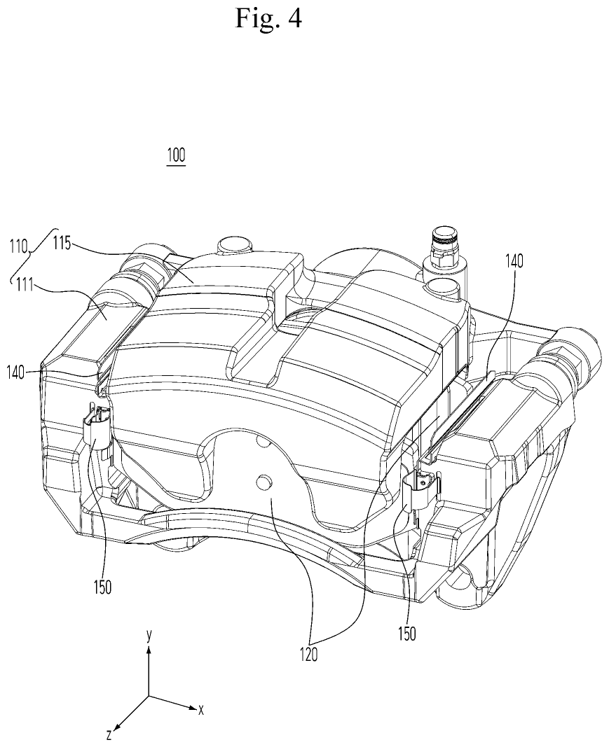

FIG. 4 is a perspective view showing the brake device 100 according to one of embodiments of the present disclosure. In FIG. 4, the brake device 100 is assembled to the caliper body 110, and the pad liner 140 is changed while the caliper body 110 may be the same as the conventional caliper body 110 in FIG. 2.

The pad liner 140 according to the present disclosure may have a shape that protrudes in the second direction of the brake pad 120 to increase a return elastic force as compared to a conventional pad liner.

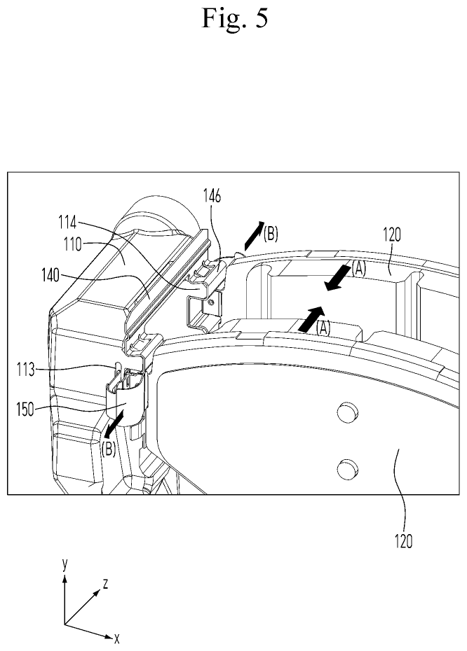

FIG. 5 is a view showing a coupling portion of the brake pad 120 of the brake device 100 according to one of embodiments of the present disclosure, with the second caliper body 115 removed such that the brake pad 120 and the pad liner 140 are visible.

The pad liner 140 according to the present disclosure is located on the side of the brake pad 120 and provides the elasticity to maintain the gap with the caliper body 110. The brake pad 120 is coupled to the caliper body 110 so as to be movable within a certain range for braking, but should not be fixed. Further, too great movable range of the brake pad 120 leads to the noise and reduced braking performance, so that the pad liner 140 with appropriate elasticity is required.

The pad liner 140 provides support elasticity in the vertical direction (a y-axis) to location the brake pad 120 in the vertical direction, return elasticity (a z-axis) to provide the restoring force in the second direction, and horizontal elasticity (an x-axis) to prevent an asymmetrical application of the force, which occurs when the brake pad 120 is misaligned in the horizontal direction, causing a misalignment in the location to be pressurized by the piston.

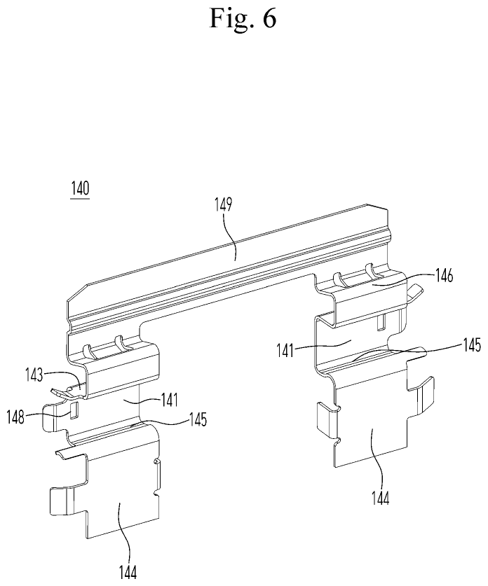

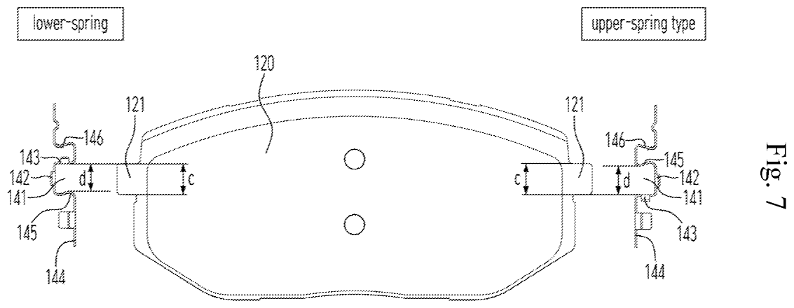

FIG. 6 is a perspective view showing the pad liner 140 according to the present disclosure, and FIG. 7 is a view showing the brake pad 120 and the pad liner 140 according to one of embodiments of the present disclosure.

A pair of pad liners 140 may be located on both left and right sides to simultaneously cover the pair of brake pads 120, and a bridge 149 for connection of the pad liner 140 may be located at a top. The pad liner 140 may include a first pad clip 141 that vertically surrounds the side protrusion of the brake pad 120. The bridge 149 may be located above the first pad clip 141, and a torque support 144 that is located between the side surface of the brake pad 120 and the caliper body 110 may be located under the first pad clip 141.

When the brake pad 120 comes into contact with the brake disc 10, a torque is generated as a force is applied in a rotation direction of the brake disc 10 because of a rotational force of the brake disc 10. The torque support 144 is a member to support the torque.

The conventional pad liner 140 has the vertical elastic portion 145 that vertically supports the brake pad 120 under the torque support 144, but the pad liner 140 according to the present disclosure omits the vertical elastic portion 145 located at the bottom.

Instead, the vertical elastic portion 145 is implemented on one side of the first pad clip 141, so that the first pad clip 141 supports the brake pad 120.

The first pad clip 141 may have a vertically bent shape, include the reference surface located on top of or beneath the side protrusion and the vertical elastic portion 145 located on an opposite side thereof, and include a clip side portion 142 that connects the vertical elastic portion 145 and the reference surface to each other.

A left side of FIG. 7 shows an embodiment in which the vertical elastic portion 145 is located beneath the side protrusion, and a right side shows an embodiment in which the vertical elastic portion 145 is located on top of the side protrusion. Because both embodiments use the first pad clip 141 into which the side protrusion is inserted, the elasticity in the vertical direction may be supported regardless of the location of the vertical elastic portion 145.

The vertical elastic portion 145 may have an angle equal to or smaller than 90° with the clip side portion 142, and may form an entrance of the first pad clip 141 such that a size ‘d’ of the entrance is smaller than a vertical length ‘c’ of the side protrusion. Such a bent shape for the vertical elastic portion 145 may provide the elasticity in the vertical direction for applying pressure to the side protrusion, thereby minimizing vertical shaking of the brake pad 120.

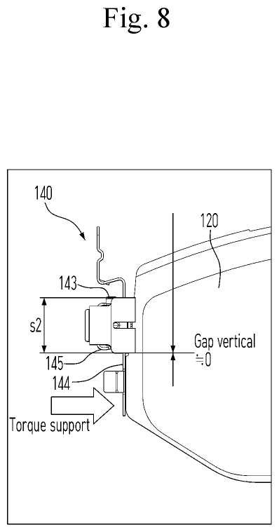

FIG. 8 is a diagram showing a state in which the pad liner 140 is coupled to the brake pad 120. A distance s2 between the vertical elastic portion 145 of the pad liner 140 and the reference surface of the pad liner 140 in the present disclosure is smaller than a distance s1 between the vertical elastic portion 145 and the reference surface of the conventional pad liner 140 in FIG. 3.

When the distance between the vertical elastic portion 145 and the reference surface is small, greater elasticity may be provided in the vertical direction, so that the gap between the pad liner 140 and the first pad clip 141 may be designed to be close to 0, thereby reducing the noise.

For convenience of description, the different pad liners 140 are shown on the left and right sides in the drawing. However, to implement a bilaterally symmetrical structure, it is desirable to use the same type of pad liner 140 on the left and right sides.

The caliper body 110 may include a side slot defined at a location corresponding to the side protrusion of the brake pad 120. The side slot may have a slot shape extending in the first direction to allow the movement of the brake pad 120 in the first direction and the second direction.

The caliper body 110 may further include an upper protrusion 114 protruding in a direction of the brake pad 120 upwardly of the side slot. The pad liner 140 may be fixed to the caliper body 110 via a caliper clip 146 surrounding the upper protrusion 114, and a lower portion of the caliper clip 146 may be an upper portion of the first pad clip 141.

The pad liner 140 may be curved in the horizontal direction in a serpentine shape and extend upward, so that the side protrusion of the brake pad 120 may be inserted thereinto on one side and the upper protrusion 114 of the caliper body 110 may be inserted thereinto on the other side.

Referring to FIG. 5, the piston pressurizes the brake pad 120 in a first direction ‘A’ such that the brake pad 120 is in contact with the brake disc 10, and the return spring 150 provides the return elastic force of restoring the brake pad 120 to the original location thereof in a second direction 13′, which is the opposite direction of the first direction.

The return elastic portion 152 of the conventional pad liner 140 may be located inwardly of the brake pad 120 and push the brake pad 120 to restore the same to the original location thereof, but the return spring 150 according to the present disclosure may have a form of pulling the brake pad 120 in the second direction.

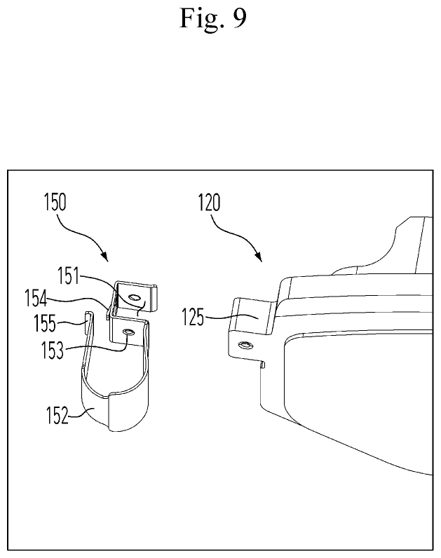

FIG. 9 is a diagram showing the return spring 150 of the brake device 100 according to one of embodiments of the present disclosure. Referring to FIG. 9, the return spring 150 may include a second pad clip 151 surrounding the side protrusion protruding in the lateral direction of the brake pad 120.

The second pad clip 151 is located inwardly of first pad clip 141, but orthogonally intersects the first pad clip 141. The first pad clip 141 surrounds the side protrusion in the vertical direction, and the first pad clip 141 surrounds the side protrusion in a front and rear direction.

The first pad clip 141 has the vertical elastic portion 145 that limits the movement of the brake pad 120 in the vertical direction (the y-axis direction), and the second pad clip 151 is connected to the return elastic portion 152 that guides a movement in the front and rear direction (the first direction and the second direction, the z-axis direction) of the brake pad 120.

The return elastic portion 152 extending in the second direction from the second pad clip 151 is bent in a U-shape, and one end thereof is seated on the second pad clip 151 and the other end 155 thereof is seated on the caliper body 110 as shown in FIG. 5. A groove 113 may be defined in the caliper body 110 to fix the other end 155 of the return elastic portion 152.

Unlike the conventional return elastic portion 152, the return elastic portion 152 according to the present disclosure protrudes in the second direction of the brake pad 120 and pulls the brake pad 120 to move the same in the second direction.

A fixing groove may be defined in each of front and rear surfaces of the side protrusion such that the second pad clip 151 may be fixed to the side protrusion of the brake pad 120, and a fixing protrusion 153 corresponding to the fixing groove may be formed on the second pad clip 151.

The second pad clip 151 may include a centering elastic portion 154 that protrudes toward the clip side portion 142 of the first pad clip 141. The centering elastic portion 154 serves to guide the location of the brake pad 120 in the horizontal direction. When the brake pad 120 is biased to one side, an imbalance may occur in the force applied to the brake pad 120 when a pair of pistons pressurize the brake pad 120 from the left and right. Because of the force imbalance, wear may occur on only one side of the brake pad 120, which shortens a lifespan of the brake pad 120.

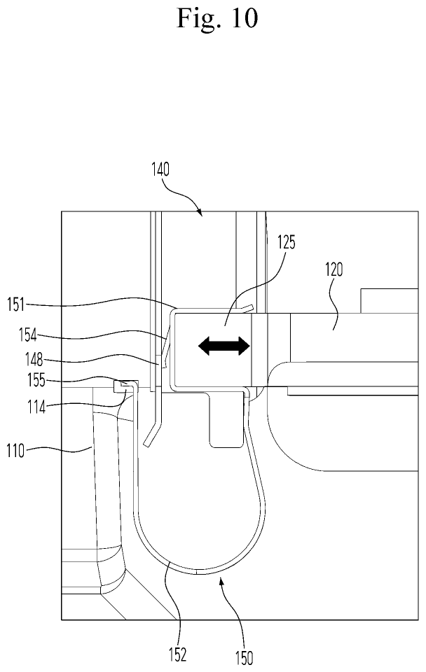

The centering elastic portion 154 may have a leaf spring shape of the second pad clip 151 that protrudes from the clip side portion 142 toward the first pad clip 141. FIG. 10 shows a direction of the force of the centering spring. Because the pad liners 140 are located on the left and right sides of the brake pad 120, respectively, the force may be balanced via the pair of pad liners 140.

Additionally, the movement of the brake pad 120 in the second direction may be restricted using the centering spring. When the brake pad 120 moves too much in the second direction, the return elastic portion 152 may be overloaded or the brake pad 120 may collide with the piston, causing damage to the piston.

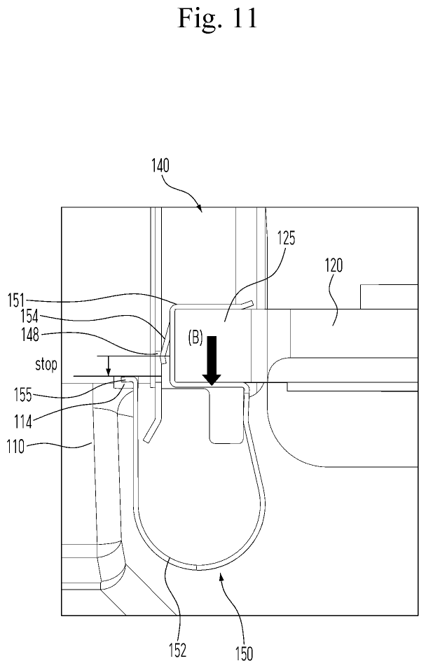

Accordingly, a pad deviation preventing groove 148 that catches an end of the centering elastic portion 154 may be further disposed on an elastic side portion of the pad liner 140. As shown in FIG. 11, the centering elastic portion 154 is not inserted into the pad deviation preventing groove 148 at a correct location, but when the brake pad 120 moves excessively in the second direction, the centering elastic portion 154 is inserted into the pad deviation preventing groove 148.

The centering elastic portion 154 is not able to move further at an end in the second direction of the pad deviation preventing groove 148, so that the pad deviation preventing groove 148 may simultaneously serve as a stopper that limits the movement of the brake pad 120 in the second direction.

As described above, the pad liner 140 according to the present disclosure limits and guides the movement of the brake disc 10 in the x-, y-, and z-axes to minimize the noise, achieve the balance, and support the brake pad 120 to be disposed at the correct location.

According to one of the embodiments of the present disclosure, the gap between the reference surface and the vertical elastic portion 145 of the pad liner 140 may be reduced to minimize the vertical gap and the movement of the brake pad 120.

Additionally, the return spring 150 having a return force greater than a pad sliding force may be provided.

Additionally, the lateral gap of the brake pad 120 may be kept constant using the center spring.

The detailed description of the exemplary embodiments of the present disclosure disclosed as described above is provided to enable those skilled in the art to make and practice the present disclosure. Although the above has been described with reference to exemplary embodiments of the present disclosure, it will be understood by those skilled in the art that various modifications and changes are made to the present disclosure without departing from the scope of the present disclosure.

What is claimed is:

1. A pad liner seated within a caliper body and supporting a brake pad, the pad liner comprising:
a first pad clip configured to surround and be coupled to a side protrusion protruding in a direction lateral from the brake pad; and
a torque support located under the first pad clip and located between a side surface of the brake pad and the caliper body, the torque support being configured to support a braking torque,
wherein the first pad clip includes:
a reference surface located on one of a top surface and a bottom surface of the side protrusion;
a vertical elastic portion located on a side of the first pad clip opposite from the reference surface and configured to pressurize the side protrusion in a direction of the reference surface; and
a clip side-portion configured to connect the reference surface and the vertical elastic portion to each other and surround a side surface of the side protrusion.

2. The pad liner of claim 1, wherein the clip side-portion has a length greater than a length of the side protrusion of the brake pad in a vertical direction,
wherein an angle between the vertical elastic portion and the clip side portion is equal to or smaller than 90°.

3. The pad liner of claim 1, further comprising:
a caliper clip located on the first pad clip, and
an upper protrusion protruding from the caliper body and inserted into the caliper clip.

4. The pad liner of claim 3, wherein a lower portion of the caliper clip is an upper portion of the first pad clip.

5. The pad liner of claim 1, wherein the first pad clip and the torque support include a pair of first pad clips and a pair of torque supports, respectively,
wherein the pad liner includes a bridge configured to connect upper portions of the pair of first pad clips to each other.

6. The pad liner of claim 1, further comprising a return spring configured to restore the brake pad to an original location thereof,
wherein the return spring includes:
a second pad clip located inwardly of the first pad clip and configured to surround the side protrusion of the brake pad in a direction perpendicular to the first pad clip; and
a return elastic portion that extends from the second pad clip in a return direction of the brake pad, the return elastic portion being in a U-shape such that an end thereof is seated on the caliper body.

7. The pad liner of claim 6, wherein the second pad clip includes a fixing protrusion within a fixing groove defined in the side protrusion of the brake pad.

8. The pad liner of claim 6, wherein the second pad clip further includes a centering elastic portion that protrudes toward the clip side portion and maintains a gap from the clip side portion.

9. The pad liner of claim 8, wherein:
the clip side portion further includes a pad deviation-preventing groove, and
an end of the centering elastic portion is inserted into the pad deviation-preventing groove.

10. A pad liner seated within a caliper body and supporting a brake pad, the pad liner comprising:
a first pad clip configured to surround and be coupled to a side protrusion protruding in a direction lateral from the brake pad;
a pad support located under the first pad clip and between a side surface of the brake pad and the caliper body, the pad support being configured to support a braking torque; and
a return spring configured to restore the brake pad to an original location thereof,
wherein the return spring includes:
a second pad clip configured to be positioned inwardly of the first pad clip and to surround the side protrusion of the brake pad in a direction perpendicular to the first pad clip; and
a return elastic portion extending from the second pad clip in a return direction of the brake pad, the return elastic portion being in a U-shape such that an end of the return elastic portion is seated on the caliper body.

11. A brake device comprising:
a caliper body;
a brake pad disposed in the caliper body and including side protrusions protruding in a lateral direction on left and right-side surfaces of the brake pad, respectively; and
a pair of pad liners located between the caliper body and the left and right-side surfaces of the brake pad, respectively,
wherein each of the pad liners includes:
a first pad clip configured to surround and be coupled to one of the side protrusions protruding in the lateral direction from the brake pad; and
a pad support located under the first pad clip and between the side surface of the brake pad and the caliper body, the pad support being configured to support a braking torque,
wherein the first pad clip of each of the pad liners includes:
a reference surface located on one of a top surface and a bottom surface of a side protrusion;
a vertical elastic portion located on a side of first pad clip opposite from the reference surface and configured to pressurize the side protrusion in a direction of the reference surface; and
a clip side portion configured to connect the reference surface and the vertical elastic portion to each other and surround a side surface of the side protrusion.

12. The brake device of claim 11, wherein the clip side portion has a length greater than a length of the side protrusion of the brake pad in a vertical direction, and
wherein an angle between the vertical elastic portion and the clip side portion is equal to or smaller than 90°.

13. The brake device of claim 11, further comprising a return spring configured to restore the brake pad to an original location,
wherein the return spring includes:
a second pad clip positioned inwardly of the first pad clip and configured to surround the side protrusion of the brake pad in a direction perpendicular to the first pad clip; and
a return elastic portion that extends from the second pad clip in a return direction of the brake pad, the return elastic portion being in a U-shape such that an end of the return elastic portion is seated on the caliper body.

14. The brake device of claim 11, wherein the second pad clip includes a centering elastic portion that protrudes toward the clip side portion and maintains a gap from the clip side portion,
wherein the clip side portion includes a pad deviation-preventing groove into which an end of the centering elastic portion is inserted.

15. A vehicle comprising:
a vehicle body;
a wheel located beneath the vehicle body and configured to rotate;
a brake disc coupled to the wheel and configured to rotate together with the wheel;
a main braking caliper body into which one end of the brake disc is inserted;
a brake pad disposed in the caliper body and including side protrusions protruding in a lateral direction on left and right-side surfaces thereof, respectively; and
a pair of pad liners located between the caliper body and the left and right-side surfaces of the brake pad, respectively,
wherein each of the pad liners includes:
a first pad clip configured to surround and be coupled to one of the side protrusions protruding in the lateral direction from the brake pad; and
a pad support located under the first pad clip and between the side surface of the brake pad and the caliper body, the pad support being configured to support a braking torque,
wherein the first pad clip of each of the pad liners includes:
a reference surface located on one of a top surface and a bottom surface of the side protrusion;
a vertical elastic portion located on a side of the first pad clip opposite from the reference surface and configured to pressurize the side protrusion in a direction of the reference surface; and
a clip side portion configured to connect the reference surface and the vertical elastic portion to each other and surround a side surface of the side protrusion.
